(19) United States
(12) Patent Application Publication
(10) Pub. No.: US 2006/0052219 A1
(43) Pub. Date: Mar. 9, 2006

(54) METHODS AND SYSTEMS FOR REHABILITING AND RETRAINING OF THE NECK MUSCLATURE

(76) Inventors: Brendan Roberts, Aspen, CO (US); Sam Patterson, Fort Lauderdale, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 10/709,477

(22) Filed: May 7, 2004

Related U.S. Application Data
(60) Provisional application No. 60/468,866, filed on May 8, 2003.

(51) Int. Cl. A63B 23/025; A61H 1/00

(52) U.S. Cl. 482/10; 601/39; 601/23; 482/91

(57) ABSTRACT

System, methods and devices for training, stretching, relaxing and rehabilitating the musculoskeletal system of the neck and upper thorax. A method uses the principles of reciprocal inhibition to specifically train the core musculature. The device employed by the method is an inflatable bladder having finger holes formed in its opposing ends.

### BACKGROUND OF INVENTION

There has been a long felt need for an exercise device for training the muscles of the cervical and upper thoracic spine which is safe, effective, comfortable, lightweight, inexpensive, portable, adjustable, and collapsible for storage. Further, there has been a long felt need for such an exercise device which also provides resistance training forces which are not associated with inertia effects or frictional effects and which are associated with as low an effective spring constant as possible. Further, there has been a long felt need for such an exercise device which avoids subjecting the spine to compressive forces while training. Further, there has been a long felt need for such an exercise device to provide resistance training in all directions of movement.

In addition to simple strength conditioning, the treatment of cervical and upper thoracic spinal movement disorders is of great concern for health care professionals, including physical therapists, chiropractors and others. Stress and tension patterns induced by driving in traffic, talking on the phone, working on the computer, etc, can cause the primary movers to become overused thereby overpowering and weakening the underlying core stabilizer muscles. Some patients, especially whiplash victims, also have hyper-extended ligaments, which further destabilize the neck.

The vast majority of people who experience neck pain are suffering from movement disorders such as fixation patterns characterized by hypertonic primary movers. In these patients, the deep, stabilizing cervical muscles such as the Semispinalis Capitis, and the Rectus Capitis are weak and sometimes in spasm, rendering them largely dysfunctional.

According to Chiropractic theory, one of the causes of disk pathology is vertebral fixation patterns. Fixation patterns are characterized by two or more vertebrae moving in a particular range of motion in a locked rigid manner. In other words two or more vertebrae move together as a fixated unit in certain ranges of motion, instead of in a smooth accordion-like or cascading motion. Fixations can interfere with the osmosis of fluid into the cervical disks, causing disk pathology over time. The intervertebral disks are fed by a combination of osmosis and a pumping action caused by relative movement between vertebrae. In the case of fixation patterns, the disk in the fixated segment can become dehydrated, aschemic and lose valuable disk height. In addition, the cervical segments above and below the fixation can become strained, resulting in hyper-mobility and ligament damage.

Often an individual may be suffering from injuries to these regions such as whiplash or other occurrences. Individuals may also suffer from degenerative conditions. These situations may require extensive treatment. Thus, an area of particular concern includes the treatment of the muscles that stabilize these injured and/or degenerated areas, particularly in the region of the neck and upper thoracic spine. These postural stabilizing muscles, also referred to as the intrinsic muscles or the core musculature of the spinal region, are critical in maintaining posture and core stabilization.

The treatises ANATOMY, A Regional Atlas of the Human Body, Third Edition by Carmine D. Clemente, Ph. D. and MYOFASCIAL PAIN AND DYSFUNCTION, The Trigger Point Manual, by Janet G. Travell, M.D. and David G. Simons, M.D. are incorporated herein by reference. However, these references are not admitted to be prior art with respect to the present invention by their mere mention in the background.

The following table was compiled from a study of Figures 151, 525, 526, 529, 594, and 647 of ANATOMY; and also from a study of Chapters 6, 7, 15, 16, 17, 19, 20, 23, and 24 of MYOFASCIAL PAIN AND DYSFUNCTION. Figure 16.8 on page 316 of MYOFASCIAL PAIN AND DYSFUNCTION illustrated by Barbara D Cummings has also been adapted in FIGS. 12 16 of the present application. The musculature of the neck and upper thorax include the following muscles and their functions:

Intrinsic movers and stabilizers of the cervical and upper thoracic spine. These muscles attach directly to at least one and in most cases several vertebrae. They are the deeper core stabilizing muscles:
Obliquus Capitis Superior extension of skull with respect to atlas
Obliquus Capitis Inferior stabilization of atlas to second vertebra
Spinalis Capitis extension of cervical spine and skull
Spinalis Cervicis—extension of cervical spin
eInterspinalis Cervicis extension of cervical spine
Intertransversarii Cervicis lateral flexion of cervical spine
longus colli forward flexion of cervical spine
longus capitis forward flexion of cervical spine and skull
rectus capitis anterior stabilization of skull to atlas
rectus capitis lateralis stabilization of skull to atlas
rectus capitis posterior minor stabilization of skull to atlas
rectus capitis posterior major stabilization of skull to first two vertbrae
Rotatores—extension, lateral flexion, and rotation of the cervical spine as well as positional adjustments between vertebrae
Cervical Multifidi—lateral flexion of cervical spine as well as positional adjustments between vertebrae
Semispinalis Cervicis extension, rotation and lateral flexion of cervical spine as well as fine positional adjustments between vertebrae
Semispinalis Capitis—extension of skull Splenius capitis—extension of skull and cervical spine, rotation of skull
Splenius cervicis extension, rotation and lateral flexion of cervical spine
Longissimus capitis lateral flexion and extension of cervical spine
Longissimus cervicis lateral flexion and extension of cervical spine
Scaleni lateral and anterior flexion of cervical spine, and elevation of upper ribs during inhalation
Levator scapulae—elevation and rotation of scapula thus elevation of shoulder
Extrinsic movers of the cervical and upper thoracic spine.
upper Trapezius lateral flexion and rotation of the cervical spine, elevation of scapula thus elevation of shoulder. While this muscle does attach to all of the cervical and thoracic vertebrae at the dorsal tips of the spinous processes, it is the most superficial muscle. It is considered an external primary mover and not a core stabilizer.

Sternocleidomastoid forward and lateral flexion, rotation of the cervical spine; elevation of anterior upper rib cage during inhalation, and elevation of clavicle thus elevation of shoulder. This muscle is very superficial and does not attach directly to any vertebrae. It is considered an external primary mover and not a core stabilizer.

Antagonists with respect to elevation of shoulder which therefore reflexively inhibit the Upper Trapezius, Levator scapulae, and Sternocleidomastoid according the principle of reciprocal inhibition:
Pectorales—pulls shoulder downward among other functions
Latissimus Dorsi—pulls shoulder downward among other functions Antagonists with respect to elevation of the anterior upper rib cage during inhalation which therefore reflexively inhibit the Scalenes and Sternocleidomastoid according to the principle of reciprocal inhibition:
Rectus Abdominis—pulls anterior ribcage down among other functions
Oblique Abdominis—pulls anterior ribcage down among other functions.

A primary goal of the treatment of whiplash and other neck and upper spinal injuries is to rehabilitate and strengthen the core musculature of the neck and upper thorax. These muscles are listed above under the heading Intrinsic movers and stabilizers of the cervical and upper thoracic spine.

The effects of injury such as whiplash include chronic pain, chronic muscular tension, poor posture and weakened ligaments. When an injury leaves the ligaments in a weakened or hyper extended condition, the deep postural or intrinsic muscles are automatically recruited to stabilize the affected segments on an emergency basis. This is not an ideal situation since muscles cannot constantly splint unstable spinal segments without soon becoming weak and spasmodic. The recruitment of intrinsic muscles to splint an unstable neck can force the head forward and can reduce the natural curvature which is characteristic of a healthy, stable neck. The compromised posture reduces the space for nerve pathways and can result in nerve compression.

The compromised posture can also cause the larger outer muscles such as the trapezius, and sternocleidomastoid to do the work of stabilizing the neck. This compensation for instability can often result in a limited range of motion, pain and tension. The trapezius, and sternocleidomastoid muscles are designed to lift the shoulders and move the neck. Optimally they are not involved in maintaining the delicate structural balance of the cervical vertebrae and the postural relationship between the head and neck. This dysfunctional pattern or imbalance must be corrected to restore optimal function, mobility and posture of the neck.

Typically during the rehabilitation of injuries to the neck and upper thoracic spine, a therapist will give a patient a device such as a foam rubber or inflated rubber ball to push against a wall with the head, or teach the patient to do resistance exercises with their hands pushing against their heads. If one is pushing a ball against a wall or using their hands to push against their heads as is common practice, there is not necessarily a precision of isolation of the core stabilizer muscles. Particularly in the case of using the hands to apply resistive forces to the head, the large primary movers, which may also be in spasm, tend to over power the deep postural muscles, thus exacerbating the imbalance that needs to be corrected.

Just as the ligaments are connecting bone to adjacent bone, the deep postural intrinsic muscles are maintaining the structural integrity of the bone to bone relationships. For example, the rotatores cervicis muscles originate on the spinous process of one vertebra and insert in the transverse process of the inferior vertebra. Many of the deep postural muscles not only connect to the bone but also to the intervertebral discs and to the ligament structures in general, thereby adding to the structural stability and movement of the spine. Hence, the importance of having strength and flexibility in the deep postural muscles especially in the case of ligament injury.

As an example, another condition that arises from injuries to the neck and upper thoracic spine region is tension in the scalene muscles. The scalene muscles are core stabilizer muscles that originate on the transverse processes of the second through seventh cervical vertebrae and attach to the first and second ribs. Chronic tension in the Scalenes is often seen clinically and is known as a form of tortacolis. This is yet another condition that requires strengthening and rehabilitation of the core stabilizer muscles.

There are numerous other conditions that require the strengthening and rehabilitation of the core, stabilizer, intrinsic cervical and upper thoracic spinal muscles. Thus, there is a need for methods and systems to enable the isolation and training of these muscles.

There have been numerous attempts to solve this problem in the past. One prior art device comprises a compressible foam ball pierced by a hole which is lined with a hard plastic tube. An elastic strap is passed through the hole so that the ends of the strap hang out of the tube. The strap is thin and wide and is structurally similar to dental dam material. The ball can be placed behind the neck and the ends of the elastic strap can be grasped in the hands. The elastic strap is tensioned by the hands in front of the chest and the resulting pressure of the ball on the base of the skull, neck and upper thoracic vertebra provides resistance against which neck glides may be performed. Neck extensions can also be performed. A neck glide is a forward to aft translation of the skull with respect to the shoulders and is known to restore proper curvature to the upper thoracic and cervical spine so that forward head posture is reduced or corrected. Neck extensions are useful for strengthening the neck extensor muscles.

There are a number of problems that arise with the use of this device. The primary form of resistance when using this device is the spring back in the stretch cord or stretch strap. To a lesser degree, the foam of the ball is also compressed and released. The stretch cord can easily snap at the users face if it is unintentionally released in a stretched condition or if it fails by tearing. Also the force vector of the resistance is always in alignment with the strap. This is not optimal since it is better for the resistance force vector to be perpendicular to the contact area between the scull and the device as the scull rotates during rearward extensions for example.

Also, the effective spring constant of the foam rubber ball as it is compressed is relatively high. It is higher than would be the case if the compressed member was an air filled bladder. The high effective spring constant causes the resistance force to rise dramatically as the foam rubber ball is compressed.

This prior art device also has the disadvantage that it is not well suited to performing lateral flexion and extension of the neck because there is no lateral resistance without repositioning the device. Since this device requires both hands to secure the ends of the strap, the hands and therefore shoulders are in an awkward position when using this device for lateral flexion exercises.

Another prior art device is disclosed in U.S. Pat. No. 103,026 to Dederick. This patent discloses an inflatable neck collar for the purpose of sleeping comfortably when traveling. Indeed, many inflatable neck collars are on the market today for the purpose of sleeping when traveling. However, neither the disclosed device or modern usage teaches the use of the inflatable neck collar for the purpose of resistance training the neck muscles nor is the device dimensioned to be useable as an exercise device.

Another prior art device is disclosed in U.S. Pat. No. 2,051,366 to Catron. This patent discloses a neck exercise device employing a flyweight system where the flyweight is effectively pivotally mounted to the top of the user's head by means of a helmet. While this device does provide resistance to flexion and extension in all directions, it is not at all suited to performing resisted neck glides. It has the further disadvantage that the flyweight exerts a constant compressive force on the neck. It is also heavy, cumbersome and not easily portable.

Another prior art device is disclosed in U.S. Pat. No. 2,958,156 to Schmahl. This patent also discloses a helmet and flyweight system where the flyweight is effectively pivotally mounted to the top of the user's head. This device is intended primarily as an entertaining novelty and as an exercise device has similar disadvantages to the Caltron device.

Another prior art device is disclosed in U.S. Pat. No. 4,988,093 to Forrest. This device discloses a head mounted device. In this case the resistance is in the form of a fluid filled annulus. The annulus is only partially filled with for example water. As the user oscillates his head the water is swirled around the annulus. A second annulus consisting of an air filled bladder is adjustably inflated to comfortably accommodate different sizes of user's heads. Again, this device is not suited to performing resisted neck glides which are the primary antidote to forward head posture and therefore very important. It also exerts compressive forces on the neck.

Another prior art device is the Nautilus™ Four Way Neck Machine. This machine can be used to perform resisted neck flexion and extension in all directions and also can be used to perform resisted neck glides. One problem with this device aside from the obvious problems of size, expense and lack of hygiene at the face pad is that the form of resistance is a vertical stack of weights which have inertia. The inertia comes into play when using the neck to get the stack to move initially and to get it to come to rest at the end of a movement. It can also come into play at the top of a movement when the stack and neck are changing direction. The inertia first causes slack in the linkage then a snap or shock as the slack is taken out. This shockwave is known to be detrimental to the neck ligaments.

This machine has the further disadvantage that the resistance or weight choices selectable by means of a pin in the weight stack are more suitable for a football or rugby player than the average person attempting to strengthen a weak neck. At the lowest weight selections, friction in the linkage becomes a problem also.

A further disadvantage of this machine is that the face pads are mounted so as to pivot on an axis roughly corresponding to the base of the neck of an average person. This is not a problem for performing extensions and flexions, however it does present a problem when using the machine to perform rearward neck glides. The problem is that the point of contact between the face pad and the back of the head changes because the pad is rotating and the head is not. This effectively makes the resistance spike way up at the rearmost excursion of a neck glide. This occurs because the point of contact between the head and the pad moves closer to the axis of rotation of the face pad losing mechanical advantage over the weight stack.

Another prior art device known as the PneuBack System™ addresses the problems of inertia and the changing mechanical advantage. This system uses an air spring to alleviate the inertia problem. It also uses linear bearings to eliminate the rotation of the face pad. In fact, the PneuBack System doesn't use face pads at all but instead delivers resistance by means of smaller pads that apply forces directly to the neck. But in any case, the use of linear bearings does alleviate the problem of loss of mechanical advantage over the weight stack at the rearmost excursion of a neck glide associated with pivotally mounted face pads.

The Pneuback System has the further advantage that the resistance can be adjusted down to a much smaller force than the Nautilus Four Way Neck Machine. Therefore it is much more suitable for the average person and for persons with neck instabilities.

However, the linear bearings and associated pneumatic seals do have the disadvantage of friction which becomes more of a factor at the lower force settings. In general, for resistance training it is desirable to have the amount of resistance for the negative component of a movement substantially equal to or if possible greater than the resistance for the positive component of a movement. For this type of resistance training machine, the positive component of movement displaces the weight or air spring from the start or rest position, and the negative component of movement allows the weight or air spring to return to the start position. The friction vector associated with the friction in the linear bearings and their associated pneumatic seals always opposes the direction of motion. Therefore frictional forces will add to the positive resistance and subtract from the negative resistance. This goes counter to the generally accepted principles of resistance training. This counter productive effect is diminished at higher pressure or force settings, but most patients training for rehabilitative purposes will use the lower force settings.

Other obvious disadvantages to the PneuBack System™ are that the system costs over $30,000. and requires a dedicated four by eight foot space. To be fair, it is a complete spinal conditioning device and is excellent for performing rearward neck glides. However, it is not suitable for neck extensions or flexions whether they be fore to aft or lateral. Therefore it does not provide a complete, stand-alone, inexpensive, light weight, portable neck training device.

None of the prior art devices and methods have been able to provide a simple device that can be used without assistance to train and rehabilitate and neck and upper thoracic spine. There presently is a need for such a device and for methods to implement this device.

### SUMMARY OF INVENTION

The present invention provides a device for training the muscles of the cervical and upper thoracic region. The present invention provides such a device which is safe, effective, comfortable, lightweight, inexpensive, portable, adjustable, and collapsible for storage. The present invention provides such a device which also provides resistance training forces which are not associated with inertia effects or frictional effects and which are associated with a low effective spring constant. The present invention provides such a device which also avoids subjecting the spine to compressive forces while training. The present invention provides such a device which also provides resistance training in all directions of movement.

In addition to simple strength conditioning, the present invention also provides systems and methods for isolating, training, stretching and relaxing the deep postural muscles of the cervical and upper thoracic spine. It also provides systems and methods for clearing fixation patterns. It also provides systems and methods for training, stretching and relaxing the large external primary mover muscles of the neck. The present invention utilizes the underlying principles of reciprocal inhibition, hold and release and others to accomplish these systems and methods. Other principles are utilized as well in other preferred embodiments.

The device of a preferred embodiment of the present invention includes a resilient bladder. The resilient bladder may include air pressure, fluid pressure, gel, elastomers, or other types of material that will provide resilience. In a preferred embodiment, the pressure of the resilience is adjustable so the amount of pressure and/or the resistance can be adjusted. The device is preferably able to conform to the shape of the neck of the individual. The device may also include finger holes to assure that the individual may properly grasp and use the device.

This device offers many advantages for isolating, training, stretching and relaxing the deep postural muscles of the cervical and upper thoracic spine. One such advantage is the absence of inertia associated with the resistance forces against which exercises are performed. The mass of the device of a preferred embodiment, and its associated inertia is negligible.

Another advantage offered by a preferred embodiment of the present invention is that the effective spring constant of the resistance forces associated with the resilient bladder of a preferred embodiment of the device is very low. This means that the resistance forces are fairly constant as deflection of the device occurs during an exercise movement.

A preferred embodiment of the present invention utilizes the principle of the inhibitory reflex also known as reciprocal inhibition for therapeutic benefit in the treatment of the deep postural muscles of the cervical and upper thoracic spine. Therapy patients are instructed to cross the arms in front of the chest, grasp the finger holes with the device wrapped around the neck, and pull down slightly on the trainer device using their latissimus dorsi and pectoralis muscles. Moderately engaging these muscles causes the antagonist muscles, the Trapezius, Sternocleidomastoid and the Levator scapulae, to substantially relax. According to the principle of reciprocal inhibition, when a muscle is engaged, the action of its antagonist, or opposing muscle, is inhibited. For example, if the Biceps is contracted, the Triceps is automatically inhibited or relaxed by the nervous system. Thus, as used in a preferred embodiment of the present invention, a muscle or group of muscles can be relaxed by contracting the opposing muscles. The inhibitory reflex underlies all movement patterns and gait patterns regulated by the central nervous system. A preferred embodiment of the present invention uses the principle of reciprocal inhibition to relax or inhibit the primary mover muscles in order to isolate and train the core stabilizer muscles.

In cases where the Sternocleidomastoid, trapezius and/or levator scapulae have become chronically tight as a compensation for an unstable injured neck, the condition can cause the shoulders to become chronically slightly lifted. The method of a preferred embodiment of the present invention uses the principle of reciprocal inhibition to relax or at least inhibit those muscles. With respect to the shoulders, the sternocleidomastoid, trapezius and levator scapulae are the antagonists of the latissimus dorsi and pectoralis muscles. When the shoulders are pulled down by intentionally contracting the latissumus dorsi and pectoralis muscles, the nervous system reflexively sends a signal to the sternocleidomastoid, trapezius and levator scapulae to substantially relax. This technique when used in conjunction with the device and methods of the present invention allows beneficial training of the deeper, smaller, core muscles that are usually overpowered by the larger external muscles. Once the primary mover muscles are relaxed, the method of a preferred embodiment of the present invention instructs patients to use the full range of neck motion flexion, extension, rotation and side bending to isolate and work the deep postural muscles. By directing therapeutic activity to the specific areas most in need of help, the patient can quickly develop deep, stabilizing strength.

With the exception of structural anomalies such as a disc or bone spur that should be determined by a physician, most neck tension and shoulder tension problems are not simply tension but also involve muscular weakness combined with a movement disorder. The neck is a column with seven vertebrae and many layers of muscle. When the inner layer of muscles close to the spine are weak the outer layer of muscles have to work overtime doing work that they are not designed for, the result is tension in these external muscles. Take for example whiplash or any similar neck injury, when the deep layer of ligament, tendon and muscles are injured, the large outer layer of muscles that are really designed as primary movers have to do the work of stabilization. In the cases of whiplash, neck tension, shoulder tension, or shoulder pain there is often an element of weakness in the deep layers of musculature.

The present invention, in a preferred embodiment, is designed to isolate and exercise the deep stabilizing muscles while keeping the outer muscles relaxed. When the deep stabilizing muscles are strong and functioning, the outer muscles can then relax. For example, if one is suffering from lower back pain then strengthening the abdomen will often be very helpful because the abdomen like the lower back is a stabilizer of the trunk. Similarly if one is suffering from whiplash, shoulder tension, shoulder pain, neck tension or neck pain then strengthening the deep layer of muscles will help stabilize the spine and give relief.

Another method of using a preferred embodiment of the present invention is to utilize the principal of isolation of segments. By pulling the device snugly around the neck and thereby stabilizing the mid to lower cervical spinal segments, the upper cervical muscles and segments can be isolated and trained. With the lower and mid cervical segments stabilized by the snugly supporting device, muscles that go from the skull to the C1 and C2 can be trained. The movements are right ear to towards right shoulder, left ear towards left shoulder, flexion, extension and all degrees in between. By isolating and training the segments beginning with the upper and gradually working to the lower cervical segments, a functional sequencing or cascading movement pattern can be restored.

The vast majority of people who experience neck pain are suffering from movement disorders such as fixation patterns characterized by hypertonic primary movers Fixations are present when two or more vertebrae move together as a fixated unit in certain ranges of motion, instead of in a smooth accordion-like or cascading motion. Fixations can interfere with the osmosis of fluid into the cervical discs, causing disc pathology over time. In addition, the cervical segments above and below the fixation can become strained, resulting in hyper-mobility and ligament damage.

The present invention also provides methods for clearing fixation patterns. For example consider the scalene muscles which attach to the cervical vertebrae C2 through C7 at their upper attachments and to the first and second ribs at their lower attachments. The scalenes have a core stabilizer function with respect to C2 through C7. They are involved with lateral and forward flexion of the neck and are also involved in lifting the top two ribs during forceful inhalation. If the cervical spine is fixated in any segment between C2 through C7 during lateral flexion, then the fixation can be released by the following technique. The technique is known as hold and release and is even more effective when used in conjunction with the methods and devices of the present invention.

In the case of a fixation involving the Scalenes, the patient is instructed to flex laterally say to the right working gently against the resisting forces of the device of the present invention. This contracts the scalenes and other muscles on the right side of the neck. The flexion and contraction of the right side will stretch and reflexively inhibit the Scalenes and other muscles on the left side. The patient is told to hold this leftward lateral flexion momentarily and then slowly release. As the left side slowly releases, the inhibited right side Scalene starts to fire one segment at a time. This forces the upper attachments of the Scalenes for example to fire independently. As the Scalenes are retrained to fire each segment sequentially, the fixation between associated vertebrae will eventually clear. The device of the present invention substantially alleviates all friction and inertia effects that would interfere with the important negative (releasing) phase of this movement. Additionally, the core muscles which include the scalenes are isolated by engaging the pectoralis and latissimus dorsi muscles.

Through isolated training of individual neck segments, patients can restore strength and proper function to the cervical musculature, clear their fixation patterns, and experience the functional accordion-like movement of a healthy spine.

Another preferred embodiment of the present invention uses tractioning forces to reduce compressive forces on the neck tissues during training and stretching. The tractioning forces result from a bladder of a preferred embodiment of the present invention. Pressure from the bladder is directed to the under sides of the skull and jaw while training or stretching. As the left side muscles pull the neck and skull up and over the device of a preferred embodiment, the device applies downward forces to the shoulder and upward forces to the neck and lower portion of the skull. The novel tractioning function occurs in all directions of movement.

The tractioning effect achieved by the device of a preferred embodiment of the present invention is beneficial and contrasts sharply with the conventional method of using a soft ball against a wall. Returning to the example of leftward lateral flexion above, as the head tips from a neutral position toward the wall compressing a prior art ball, the ball typically rolls up toward the top side of the head. The force vectors between the ball and the top side of the head direct compressive forces to the cervical spine.

The resilient bladder of the present invention also substantially provides a fulcrum effect. As the head goes up and over the resilient bladder, the head pivots against the bladder resulting in even more tractioning forces. The combined effects of tractioning, and pivoting about a fulcrum permit active stretching of the tissues on one side of the neck while substantially avoiding compression of the corresponding tissues on the opposite side of the neck.

The present invention can also be used in conjunction with exercise modalities such as: active assisted movement; rhythmic initiation; repeated contraction; and hold and relax techniques to improve motor control of the neck. The present invention can also help patients improve neck stability with exercise modalities such as: alternating isometric exercises; rhythmic stabilization and slow reversal-hold. These traditional modalities can be used to much greater advantage for the patient when used in conjunction with the present invention and methods.

Some neck problems can manifest as lack of proper curvature in the cervical spine (lordotic curvature). One common cause of improper lordotic curvature is hypertonic posterior neck muscles combined with weak anterior intrinsic stabilizers. This produces posterior compression of the cranial base and upper cervical vertebrae. In this situation, the head compensates by tipping forward and straightening the spine unnaturally. A unique feature of a preferred embodiment of the present invention is its ability to aid patients in isolating and strengthening the anterior intrinsic stabilizers and flexors such as the Longus colli, Longus capitis and Rectus capitis. Strengthening these muscles helps alleviate posterior compression. This therapy approach, done in conjunction with the rest of the therapeutic exercises of the present invention will help to restore the natural lordotic curvature to the cervical spine and improve its function.

Proper spinal posture is characteristic of a healthy neck. If the neck is painful and not working properly, the patient is unlikely to be able to achieve good posture. But when the primary movers are trained to relax, and the intrinsic neck stabilizers are functioning properly, the patient will experience significant and spontaneous improvement in posture.

The present invention, in a preferred embodiment, provides a series of unique movements performed with the device of a preferred embodiment of the present invention for restoring structural congruency to the cervical spine and musculature.

The present invention is an effective and inexpensive therapy for patients with chronic and acute neck pain. Whether the patient is suffering from a recent whiplash trauma or a decades old neck problem, the present invention can transform their neck from the inside out.

These and other features of the present invention will be evident from the ensuing discussion of preferred embodiments and from the drawings.

### BRIEF DESCRIPTION OF DRAWINGS

FIG. 1 illustrates a diagram of the muscle groups of the neck and upper thoracic spinal regions that appear in a cross section of the base of the neck.

FIG. 2 illustrates a diagram of the inhibited muscles during pulling down of the shoulders.

FIG. 3 illustrates a diagram of the inhibited muscles during pulling down of the upper rib cage.

FIG. 4 illustrates a diagram of the inhibited muscles during pulling down of both the shoulders and upper rib cage.

FIG. 5 illustrates the intrinsic muscle groups that appear in a cross section of the base of the neck.

FIG. 6 illustrates a neck training device of a preferred embodiment of the present invention.

FIG. 7 illustrates an alternative embodiment of the preferred embodiment of the present invention.

FIG. 8 illustrates the device of FIG. 7 in use.

FIG. 9 illustrates a side view of the support and tractioning of the embodiment of FIG. 7 in use.

FIG. 10 illustrates the device of FIG. 9 used in lateral flexion to the left.

FIG. 11 illustrates the device of FIG. 9 used in lateral flexion to the right.

FIG. 12 illustrates the device of FIG. 7 with the head and neck in neutral spine.

FIG. 13 illustrates the device of FIG. 7 with the head and neck at the rearward excursion of a front to back neck glide.

FIG. 14 illustrates the device of FIG. 7 with the head and neck at the rearward excursion of a front to back neck extension.

FIG. 15 illustrates the device of FIG. 7 in use by rotation of the neck.

FIG. 16 illustrates the device of FIG. 7 with the head and neck at the rearward excursion of an oblique neck extension (intermediate between front to back and lateral).

FIG. 17 illustrates the device of FIG. 7 with the device pulled under the chin for forward flexion.

### DETAILED DESCRIPTION

The present invention provides methods and systems for exercising the head, neck and back muscles as well as the upper thoracic spine. It is to be expressly understood that the descriptive embodiments set forth herein are intended for explanatory purposes and is not intended to unduly limit the scope of the present inventions. Other embodiments and applications not described herein are considered to be within the scope of the invention. It is also to be expressly understood that while specific embodiments for the components of the system are discussed, other equivalents to these embodiments that perform substantially similar functions are within the scope of the claimed inventions.

The method of a preferred embodiment of the present invention utilizes as an operative principle the use of the inhibitory reflex or reciprocal inhibition. As used in the present invention and as defined in this application, the inhibitory reflex occurs naturally and serves to relax a muscle when its opposing muscle is contracted. In medical terminology one would say that a contraction of the agonist automatically relaxes its antagonist. For example as one contracts the biceps the triceps will automatically relax. This principle as employed in the present invention is extremely beneficial for rehabilitating and retraining the neck musculature as described below. The present invention, in different preferred embodiments uses this principle alone as well as in combination with techniques for isolating muscles.

Reference Glossary

Reference is made to the treatises ANATOMY, A Regional Atlas of the Human Body, Third Edition by Carmine D. Clemente, Ph. D. and MYOFAASCIAL PAIN AND DYSFUNCTION, The Trigger Point Manual, by Janet G. Travell, M.D. and David G. Simons, M.D. which are incorporated herein by reference. However, these references are not admitted to be prior art with respect to the present invention by their mere mention in the detailed description.

The following table was compiled from a study of Figures 151, 525, 526, 529, 594, and 647 of ANATOMY; and also from a study of Chapters 6, 7, 15, 16, 17, 19, 20, 23, and 24 of MYOFASCIAL PAIN AND DYSFUNCTION. The following definitions of the core musculature of the neck and upper thorax include the following muscles and their functions:

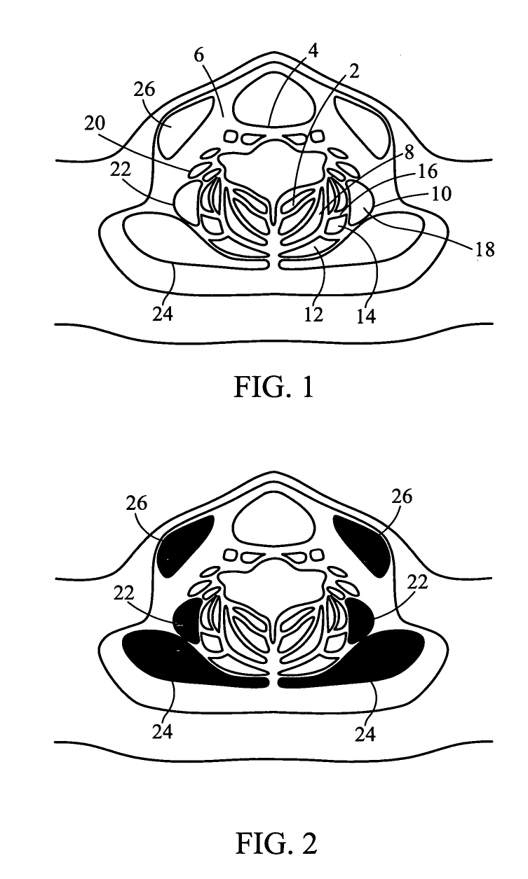

Intrinsic movers and stabilizers of the cervical and upper thoracic spine. These muscles attach directly to at least one and in most cases several vertebrae. They are the deeper core stabilizing muscles. The reference numerals indicate the muscles illustrated in FIG. 1:
Obliquus Capitis Superior extension and stabilization of skull to atlas
Obliquus Capitis Inferior stabilization of atlas to second vertebra
Spinalis Capitis extension of cervical spine and skull
2—Spinalis Cervicis—extension and stabilization of cervical spine
Interspinalis Cervicis extension cervical spine
Intertransversarii Cervicis lateral flexion and stabilization of cervical spine
4—longus colli forward flexion and stabilization of cervical spine
6—longus capitis forward flexion and stabilization of cervical spine and skull
rectus capitis anterior stabilization of skull to atlasrectus capitis lateralis stabilization of skull to atlas
rectus capitis posterior minor stabilization of skull to atlasrectus capitis posterior major stabilization of skull to first two vertbrae
Rotatores—extension, lateral flexion, and rotation of the cervical spine as well as positional adjustments between vertebrae
Cervical Multifidi—lateral flexion of cervical spine as well as positional adjustments between vertebrae
8—Semispinalis Cervicis extension, rotation and lateral flexion of cervical spine as well as fine positional adjustments between vertebrae
10—Semispinalis Capitis—extension of skull
12—Splenius capitis—extension of skull and cervical spine, rotation of skull
14—Splenius cervicis extension, rotation and lateral flexion of cervical spine
16—Longissimus capitis lateral flexion and extension of cervical spine
18—Longissimus cervicis lateral flexion and extension of cervical spine
20—Scaleni lateral and anterior flexion of cervical spine, and elevation of upper ribs during inhalation
22—Levator scapulae—elevation and rotation of scapula thus elevation of shoulder
Extrinsic movers of the cervical and upper thoracic spine.
24—upper Trapezius lateral flexion and rotation of the cervical spine, elevation of scapula thus elevation of shoulder. While this muscle does attach to all of the cervical and thoracic vertebrae at the dorsal tips of the spinous processes, it is the most superficial muscle. It is considered an external primary mover and not a core stabilizer.
26—Sternocleidomastoid forward and lateral flexion, rotation of the cervical spine; elevation of anterior upper rib cage during inhalation, and elevation of clavicle thus elevation of shoulder. This muscle is very superficial and does not attach directly to any vertebrae. It is considered an external primary mover and not a core stabilizer.

Antagonists with respect to elevation of shoulder which therefore reflexively inhibit the Upper Trapezius, Levator scapulae, and Sternocleidomastoid according the principle of reciprocal inhibition: Pe
Pectorales—pulls shoulder downward among other functions
Latissimus Dorsi—pulls shoulder downward among other functions

Antagonists with respect to elevation of the anterior upper rib cage during inhalation which therefore reflexively inhibit the Scalenes and Sternocleidomastoid according to the principle of reciprocal inhibition:
Rectus Abdominis—pulls anterior ribcage down among other functions
Oblique Abdominis—pulls anterior ribcage down among other functions.
   Method of Isolation and Rehabiliation

In a preferred embodiment of a method of the present invention, the intrinsic muscles are isolated so they may be rehabilated by using inhibitory reflex in accordance with the present invention. The user first contracts the lattisimus dorsi and pectoralis muscles with moderate intensity to pull the shoulders downward. This automatically relaxes the trapezius, sternocleidomastoid 26 and levator scapulae 22 muscles. FIG. 2 shows these inhibited muscles in black. The trapezius, sternocleidomastoid and levator scapulae muscles are synergistic with the deeper intrinsic muscles and generally overpower them. This is especially true after a whiplash type injury which results in dysfunction of the ligaments and intrinsic muscles. A reflexive relaxation of the trapezius, sternocleidomastoid and levator scapulae muscles allows the user to isolate, train and rehabilitate the deeper intrinsic muscles.

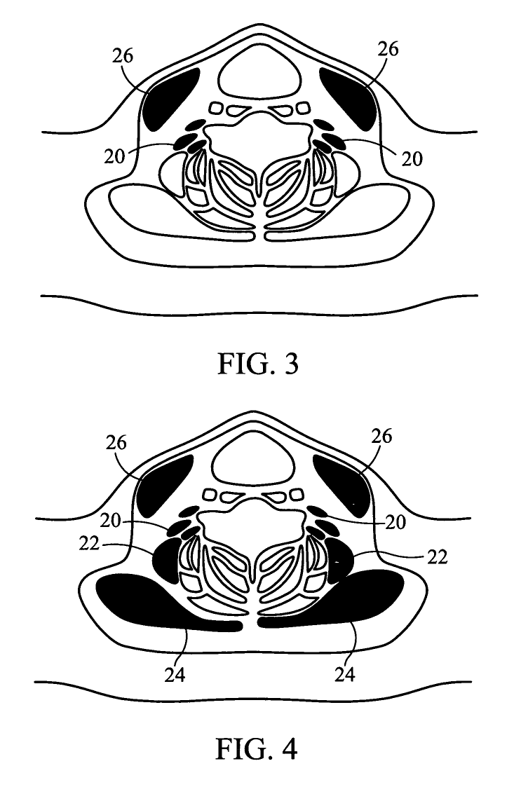

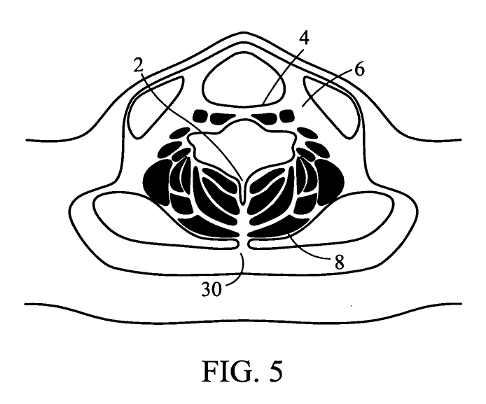

The diagram illustrated in FIG. 3 shows in an anterior view the muscles that are inhibited by pulling down the rib cage during complete exhalation. These muscles include the sternocleidomastoid 26 and the scalene muscles 20. The diagram of FIG. 4 shows in an anterior view the muscles that are inhibited by pulling down both the shoulders and the upper rib cage. The inhibited muscles include the sternocleidomastoid 26, the scaleni 20, the levator scapulae 22 and the trapezius muscles 24. The diagram of FIG. 5 illustrates the deeper instrinsic muscles 30 that are typically in need of training and rehabilitation. These muscles include the spinalis cervici and multifidius 2, the longus colli 4, the longus capitis 6 and the semispinalis cervicis 8.

The intrinsic muscles of the cervical spine attach to adjacent vertebrae. These muscles are listed in the reference glossary above under the heading Intrinsic Movers and Stabilizers of the Cervical and Upper Thoracic Spine. They generally serve to cooperate with the ligaments to stabilize each articulation of the cervical spine. However, when ligaments are damaged, the intrinsic muscles do more than their normal share of stabilization and become chronically tight. Eventually they become permanently contracted, aschemic and dysfunctional.

Isolating these muscles as described above is the first step toward rehabilitating them back to functional muscles which can contract and relax. Once the intrinsic muscles of the cervical spine have been isolated, the user can then train, stretch, relax and generally rehabilitate them using the methods and devices of the present invention.

Neck and Upper Thoracic Spinal Region Training Device

The neck training device 50 of the preferred embodiment of the present invention includes a resilient bladder. This preferred embodiment is described as an air-filled bladder, but other materials may be used as well. The bladder 50 is constructed of stretch vinyl or urethane or similar elastomeric and airtight material. The bladder 50 includes an inflation valve 52 that allows the air pressure, and thus the resistance, of the bladder 50 to be varied according to the size of the individual and the strength of the neck muscles and other variables. The bladder may also include compartments 58 as shown in FIG. 9. Also, the bladders can be provided in a range of sizes if necessary. The bladder may also be formed of a deformable elastomeric material instead of being inflatable.

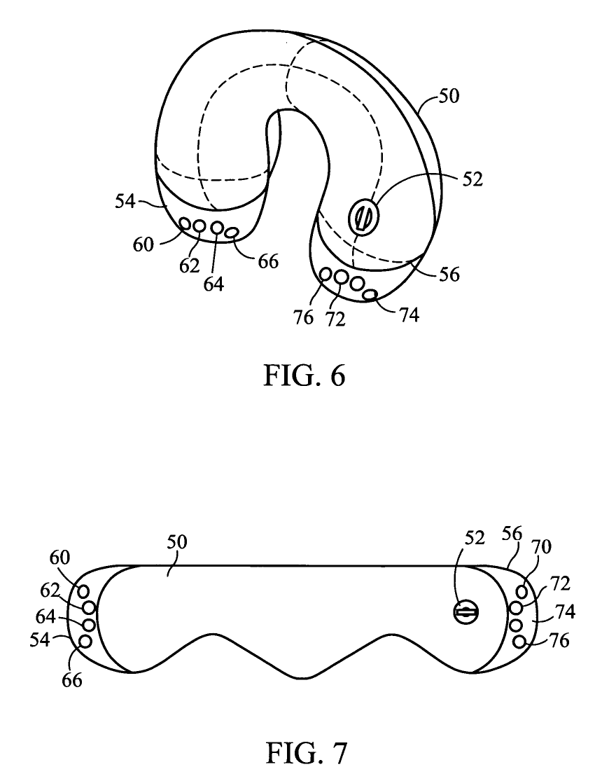

The device 50 is, in the preferred embodiment flexible to comfortably fit around the neck and over the shoulders of most individuals according to the size of the bladder. The device 50 may be relatively curved, as shown in one preferred embodiment in FIG. 6, to allow it to fit around the neck and shoulders of an individual. In the preferred embodiment, the device 50 may be elongated and flexible to fit around the neck and shoulders, as shown in FIG. 7.

The device 50 of this preferred embodiment includes two extended members 54, 56 on opposing ends of the device 50. The extended member 54 includes finger holes 60, 62, 64, and 66 while extended member 56 includes finger holes 70, 72, 74, and 76. The finger holes are sized to fit most individuals.

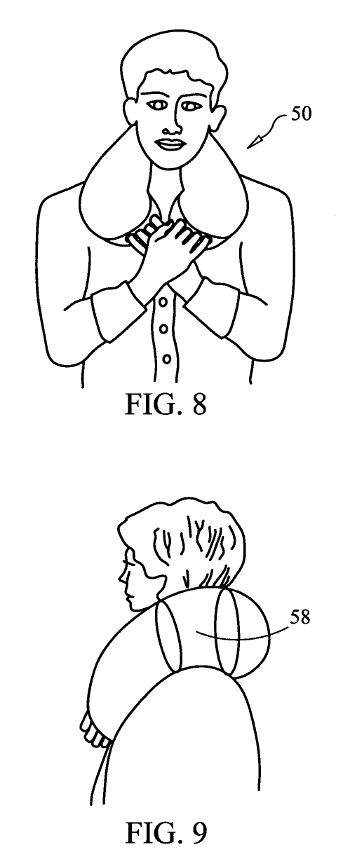

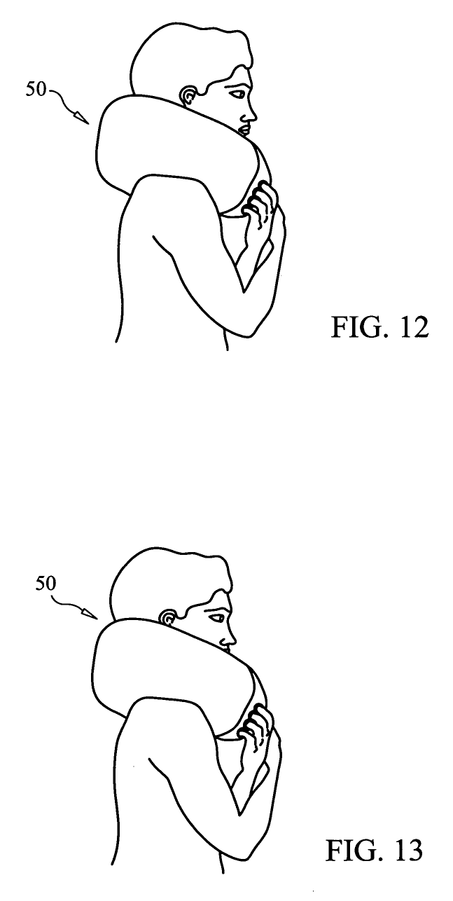

In use, the device 50 is wrapped around the neck and over the shoulders of the individual using it. The individual crosses their arms, as shown in FIG. 8 and inserts his fingers in the finger holes of the device 10. The start position is neutral spine, as shown in FIGS. 8 and 12. The device 10, as shown in FIG. 9, provides a pressure area under the skull and jaw of the user's head. This provides not only support for the user as discussed below, but also provides tractioning forces on the neck, also as discussed in greater detail below.

With the fingers engaged in the finger holes as shown, the user cinches the device around the neck to create balanced support for neutral spine. From this start position of neutral spine, the user can execute movements or excursions in all directions. The resulting deformation of the device creates resisting forces which oppose the excursions. Thus isometric and isotonic resistance training consisting of flexion, extension, rotation and oscillation are enabled in all directions of movement. These resistance forces are free from inertia effects, frictional effects, are associated with a low effective spring constant and are directed to avoid compression effects.

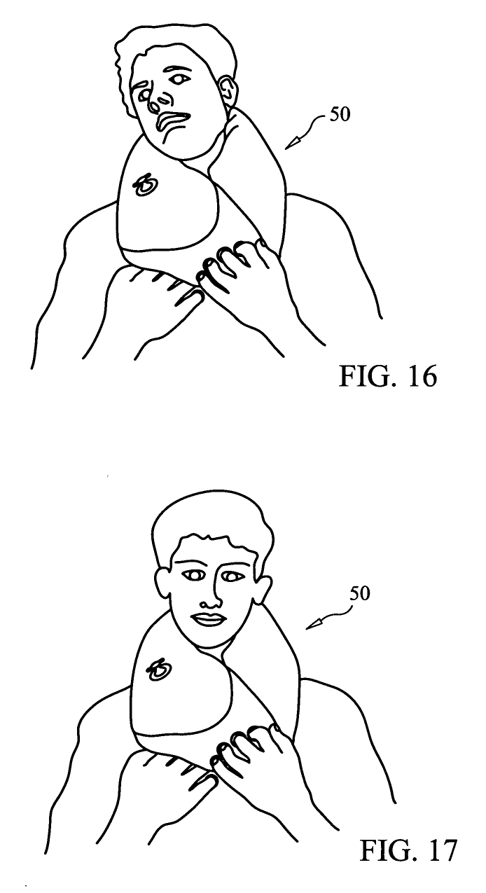

In a preferred embodiment, the user contracts the lattisimus dorsi and pectoralis muscles moderately. This automatically relaxes the trapezius, sternocleidomastoid and levator scapulae muscles, as shown in the diagram of FIG. 2. The trapezius, sternocleidomastoid and levator scapulae muscles are synergistic with the deeper intrinsic muscles and generally overpower them. The reflexive relaxation of the trapezius, sternocleidomastoid and levator scapulae muscles allows the user to isolate, train and rehabilitate the deeper intrinsic muscles as discussed above. All of the training movements and techniques described below are to be performed with the latissimus dorsi and pectoralis muscles engaged as discussed above. Some of the training techniques described below also invoke the inhibitory reflex with respect to additional directions of movement. For example, with the trapezium, sternocleidomastoid and levator scapulae inhibited by pulling the shoulders downward, the user can also exhale and contract the rectus and oblique abdominus muscles to pull the upper anterior rib cage downward. This contraction opposes the scalenes and sternocleidomastoid muscles since they are involved in elevating the upper ribs during inhalation. This is illustrated in FIG. 3 showing these muscles in black. The resulting combined inhibitory effect of pulling the shoulders down and exhaling so as to pull the ribcage downward results in a relaxation or inhibition of the trapezius, sternocleidomastoid, levator scapulae and scalenes as shown in black in FIG. 4. Obviously the user must breathe. Optimally the user would exhale at the maximum excursion (from neutral) of a stretch and inhale as the spine passes through neutral on the way to the opposite stretch. The use of these combined techniques is extremely useful for stretching the scalenes and sternocleidomastoid as is illustrated in FIG. 16.

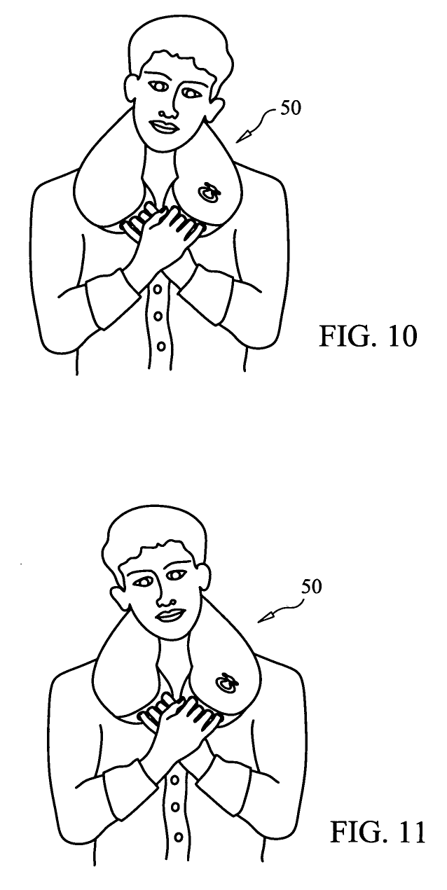

The user can use the device in a lateral flexion movement such as shown in FIG. 10. The user tilts their head and neck to the left over the device 50. This movement causes the intrinsic muscles on the left side of the neck to contract to pull the neck toward the left shoulder. During this movement, the inhibitory reflex automatically causes a relaxation of the intrinsic muscles on the right side of the neck. This allows stretching of the now relaxed right side muscles.

This movement can then be repeated in the opposing direction as shown in FIG. 11. The user tilts their head and neck to the right over the device 50. The intrinsic muscles on the right side of the neck are contracted, causing a relaxation of the intrinsic muscles on the left side of the neck. This allows stretching of the intrinsic muscles on the left side of the neck. The alternating contraction and relaxation of the intrinsic muscles of the neck are a significant step toward rehabilitating these muscles.

Avery important novel feature of the present invention enhances this opportunity by tractioning the neck as the left side intrinsic muscles pull the neck and skull up and over the device of the preferred embodiment of the present invention. Side to side flexion and extension is simply cited as an example. The novel tractioning function occurs in all directions of movement. As shown in FIG. 9, the contact surface or pressure area 50 between the device on one hand and the shoulders, neck and skull creates tractioning forces that tend to pull the skull up and away from the shoulders.

For example, as shown in FIGS. 12-13, the user may use a front to back gliding motion to perform the tractioning and reciprocal relaxing technique. The gliding technique is well known as a method for correcting forward head posture. The gentle resistance provided by the present invention particularly during the rearward movement of FIG. 13 enhances this benefit. The gliding technique involves pure translation of the head from front to back with more emphasis on the rearward portion. Glides are performed in pure translation of the head with no rotation about the transverse axis.

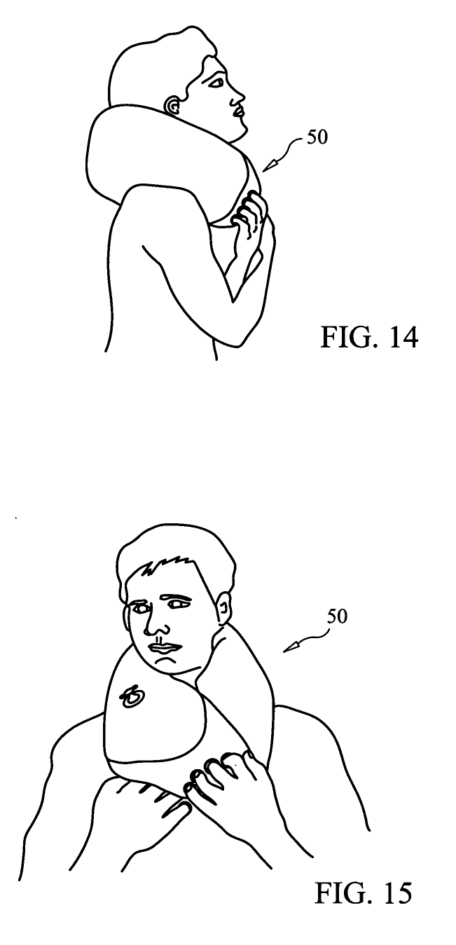

Also as shown in FIG. 14, the user may extend the head rearward while pivoting up and over the bladder. This movement illustrates the very important fulcruming effect. As the head rolls up and over the bladder, the angle of the pressure area 50 applied to the skull rotates. Obviously the force vectors remain perpendicular to the pressure contact area. This is a basic law of static fluid mechanics. As the skull rotates rearward, the angle of the pressure area contacting the skull brings the force vectors more parallel to the neck. This maximizes the equal and opposing forces that apply to the skull and shoulders thus maximizing the tractioning forces thoughout the neck.

Also, as shown in FIG. 15, the user may tuck their chin downward in an initial position and perform a neck rotation movement that will train the intrinsic muscles that are involved in rotation. These muscles comprise the rotatores, semispinalis cervicis, splenius capitis and splenius cervicis. The user simply turns to the right or left while pulling snugly on the device to oppose the movement as shown in FIG. 16.

The present invention may also be used for other neck and upper body movements to isolate, traction, and relax different muscles and muscle groups.

The system of a preferred embodiment of the present invention has an advantage in that the trapezium, sternocleidomastoid and levator scapulae muscles which are synergistic to the intrinsic postural muscles are caused to relax because of the reflexive inhibition caused by contraction of the latissimus dorsi and pectoral muscles. The exercises of the system of preferred embodiments of the present invention allow for greater use of the inhibition principal and therefore beneficial isolation of the core neck musculature. The device of the present invention is configured to position the hands and arms in a natural comfortable posture. This posture of the arms and hands is designed to enable both easy cinching of the bladder around the neck and pulling of the shoulders downward. Simply pulling the head against a strap, pushing a ball against a wall with the head or using hands to apply isometric or isotonic forces to the head as is common practice will not necessarily provide the precision of isolation that the inhibitory reflex provides in connection with the preferred embodiments of the present invention. In the absence of significant inhibition, the large primary movers which may also be in spasm and over worked will not allow the deep postural muscles to be isolated and trained. The device and methods of the preferred embodiments of the present invention will cause the large external primary mover muscles to relax and allow the deep core muscles to be trained.

A preferred embodiment of the device of a preferred embodiment of the present invention can also be used for muscle relaxation. For example, the device of this embodiment is used for treatment of a form of tortacolis due to trauma to the scalene muscles. The scalene muscles can be inhibited and relaxed using the inhibition techniques discussed above. The right and left scalene muscles oppose each other. Thus by moving into the device 50 to the right, the left side is relaxed and by moving into the device 50 to the left, the right side is relaxed. FIG. 16 illustrates this stretching and relaxing of the left side scalenes. This gentle bending motion will retrain the scalene muscles to relax and come out of a spasm reflex by isolation and inhibition. Other muscles in the upper thoracic region may be treated in this manner as well.

Another preferred embodiment of the present invention provides a method for using the device 50 in combination with stretch cords. With the stretch cords around the knees or attached to a stationary object such as a door etc. and with the user sitting with good posture, the user can relax the trapezius, sternocleidomastoid and levator scapulae by letting the arms hang and then train the deep postural muscles. The relaxing or inhibiting effect can be enhanced by reaching for the floor so as to pull downward on the shoulders.

Another preferred embodiment of the present invention provides a method of using the device 50 for isolation of segments. By pulling the device 50 snugly around the neck and thereby stabilizing the mid and lower cervical spine, the upper cervical muscles can be isolated and trained. This focuses training on muscles such as the rectus capitis group and other small muscles attach from the skull to C1 and C2. In the case of injury, where the ligaments have been over stretched and the tissues in the upper cervical area in general have been traumatized, isolating and training these muscles is of vital importance to stabilizing the upper neck.

In this case the movements are right ear to towards right shoulder, left ear towards left shoulder, flexion, extension and all degrees in between. By isolating and training the segments beginning with the upper and gradually working to the lower cervical segments, a functional sequencing or cascading movement pattern can be restored.

Another preferred embodiment of the present invention provides a method of using the device 50 for isometric and isotonic exercise within a precise range of motion. It is commonly known that it is very important for the patient to begin moving as soon as possible after whiplash. Yet, initially, the movement can be painful. With the neck training device 50, the patient can easily adjust the amount of support and traction provided by the device and thereby control the range of movement. Small movements can be performed to rehabilitate the deep layers of muscles which are vital to stabilization. The smaller movements can be performed in an extremely supportive environment. The movements activate the stabilizers and are less painful because the range of motion is controlled by the device. The primary movers are also relaxed due to the principal of inhibition as mentioned above.

Another preferred embodiment provides a method for using the device like a fulcrum in all ranges of movement. Lateral bending to the right stretches over the device 50 thereby opening and stretching the left side of the spine and the related tissues on the left. No other device will allow for such a stretch that is totally adjustable in all ranges of movement by the user, simply moving in any desired direction or by applying a different amount of tension on the devise with the hands or by inflating or deflating. Another use of the fulcrum effect is to isolate and train specific segments of the cervical spine as described above. Unlike any existing method or devise, the device 50 uses the fulcrum effect to stretch the neck in specific areas and ranges of motion safely and effectively.

Physical therapists and other persons skilled in the art may use the neck trainer of the present invention for rehabilitation purposes as referenced in: PHYSICAL REHABILITATION, Assessment and Treatment, Second Edition by Susan B. O'Sullivan and Thomas J. Schmitz, hereby incorporated in by reference. Specific exercises to Improve Mobility such as rhythmic initiation, active assisted movement, repeated contractions, hold-relax, can be performed in a unique way with the patient being assisted by a therapist. With the exception of active assisted movement, the exercises can also be performed by the patient unassisted. In a similar way patients in need of improved stability of the cervical spine can use the device and perform alternating isometrics, rhythmic stabilization, and slow reversal-hold. When patients are in need of improved motor control of the cervical spine, exercises can be done such as slow reversals, slow reversal-hold, repeated contraction and agonist reversal. The above exercises can also be done to improve motor skills.

The device 50 of a preferred embodiment of the present invention is also inertia free and has a relatively low effective spring constant. In general, the resistive forces between the air filled elastomeric bladder and the body are proportional to the deformation of the bladder. The beneficial effect of the relatively low effective spring constant is that the resistive forces do not ramp up sharply. The device 50 is constructed of stretch vinyl or urethane or similar elastomeric and airtight material. By way of comparison, when a foam rubber ball is used to exercise the neck the resisting forces do tend to ramp up sharply. A foam rubber device generally has a higher effective spring constant than an air filled elastic bladder. This is because the compressibility of foam rubber depends on the compression of air in the local area of deformation whereas in the case of an air filled elastic bladder, the deformation is absorbed by the entire structure. This is the crux of the original Dunlop pneumatic tire patent and is the reason that segmentally inflated tires gave way to continuous inner tubes.

These and other features are evident from the use of the device of a preferred embodiment of the present invention when used with the principles of the method of the present invention. It is to be expressly understood that the above explanatory embodiments are intended for explanatory purposes only and are not meant to limit the scope of the present invention.

The present invention provides methods and systems for training, strengthening, stretching, rehabilitating and otherwise treating the neck, shoulder, back, head and upper thoracic spinal muscles, segments, and other body parts. The present invention also provides devices for employing such methods.

What is claimed is:

1. A method for utilizing inhibitory relaxation for treating neck muscles, said method comprising:
providing a device for fitting around the neck and over the shoulders of an individual;
providing a mechanism for grasping the ends of said device;
placing said device around neck of an individual;
said individual grasping said device with crossed arms; and
contracting a first set of neck muscles slightly to relax the opposing set of neck muscles.

2. The method of claim 1 wherein said step of relaxing a first set of muscles includes:
stretching the neck muscles in a first direction over said device to contract the muscles on that side of the neck while relaxing the opposing muscles.

3. The method of claim 2 wherein said method further includes the step of:
stretching the neck muscles in a second direction over said device to contract the muscles on that side of the neck while relaxing the opposing muscles.

4. The method of claim 1 wherein said step of contracting a first set of neck muscles includes:
stretching the neck muscles in opposing lateral directions over said device.

5. The method of claim 1 wherein said step of contracting a first set of neck muscles includes:
stretching the neck muscles in forward and backward directions over said device.

6. The method of claim 1 wherein said step of contracting a first set of neck muscles includes:
stretching the neck muscles in a rotational direction over said device.

7. The method of claim 1 wherein said neck muscles includes the muscles of the upper thoracic body.

8. The method of claim 1 wherein said device includes:
isolating muscles by the use of said device.

9. The method of claim 1 wherein said device includes:
a resilient member that is shaped to fit around the neck of a user.

10. The method of claim 1 wherein said device includes:
a bladder that is inflatable to allow adjustment to size and resilience by inflating or deflating of said bladder.

11. The method of claim 1 wherein said grasping mechanism includes:
finger holes for allowing a user to insert their fingers for grasping of device.

12. A device for allowing inhibitory relaxation of neck muscles, said device comprising:
an elongated member shaped to fit around the neck of an individual; and
a grasping mechanism on opposing ends of said elongated member for allowing an individual to grasp said elongated member as said elongated member is wrapped around the neck of the individual.

13. The device of claim 12 wherein said device includes:
said elongated member having resilient portion for allowing an individual to stretch their neck muscles over said device.

14. The device of claim 12 wherein said device includes:
an inflatable portion on said elongated member to allow an individual to stretch their neck muscles over said device.

15. The device of claim 12 wherein said device includes:
an inflatable portion on said elongated member to allow an individual to stretch their neck muscles over said device; and
a mechanism to regulate the inflation of said inflatable portion.

16. The device of claim 12 wherein said grasping mechanism includes:
finger holes formed in said device to allow an individual to grasp the opposing end portions of said elongated member as said device is placed around the neck of an individual.

17. The device of claim 12 wherein said device includes:
a shape that allows lateral motion, forward and backward motion and rotational motion of the neck of the user of said device.

18. A device for allowing inhibitory relaxation of neck and upper thoracic muscles of an individual, said device comprising:
an inflatable member shaped to fit around the neck of an individual; and
finger holes formed on opposing ends of said device to allow an individual to grasp the device with the hands of their arms crossed over the front of their body.

19. A method for training the neck muscles, said method comprising:
providing an elastically compressible device for fitting around the neck and over the shoulders of an individual;
providing a mechanism for grasping the ends of said device;
placing said device around the neck of an individual;
grasping said mechanism for grasping the ends of said device; and
contracting neck muscles in such a way that the head and neck move to compress said device so that forces generated by said elastic compression opposing said movement of head and neck.

20. The method of claim 19 wherein said elastically compressible device comprises an air filled bladder.

21. The method of claim 19 wherein said elastically compressible device comprises a bladder made of elastomeric material.

22. The method of claim 19 wherein said step of grasping said mechanism includes:
crossing arms in front of the chest to grasp said device.

23. The method of claim 19 wherein the outer surface of said device is textured.

24. The method of claim 19 wherein said method further includes the step of:
utilizing inhibitory relaxation for treating muscles by contracting one set of neck muscles to relax the opposing set of muscles.

25. The method of claim 19 wherein said step of contracting a first set of muscles includes:
stretching the muscles in forward and backward direction over said device.

26. The method of claim 19 wherein said step of contracting a first set of muscles includes:
stretching the muscles in a rotational direction over said device.

27. The method of claim 19 wherein said muscles includes the muscles of the upper thoracic body and neck.

28. A device for allowing exercise of the neck muscles, said device comprising:
an elongated top member;
an elongated bottom member; and
a sealing mechanism for sealing said top member to said bottom member in such a way as to create an air tight cavity.

29. The device of claim 28 wherein said device further includes:
a valve mechanism for introducing and trapping air into said air tight cavity.

30. The device of claim 28 wherein said device further includes:
a grasping mechanism on opposing ends of said elongated member for allowing an individual to grasp said elongated member as said elongated member is wrapped around the neck of the individual.

31. A resilient neck and upper thoracic spinal region training device for a patient, comprising:
a flexible, resilient, generally elongated member having two ends; and
a means for securing the device around the neck and upper thoracic spinal region.

32. The device of claim 31 wherein the means for securing includes an extended member at each end.

33. The device of claim 31 wherein the elongated member is inflatable.

34. The device of claim 32 wherein one or more extended members further includes one or more voids.

35. The device of claim 31 wherein the elongated member further comprises a top portion and a bottom portion, and the bottom portion includes curvature for fitting around a patient's neck and upper thoracic spinal region.

36. The device of claim 35 wherein the curvature includes a central bulge.

37. The device of claim 35 wherein the curvature includes a recess at each end.

38. The device of claim 31 wherein the elongated member comprises material having a low spring constant.

39. An elastically compressible neck and upper thoracic spinal region training device for a patient, comprising:
means for providing reciprocal inhibition of primary mover muscles; and
means for isolating core stabilizer musculature of the neck and upper thoracic spine for strengthening.

40. The device of claim 39 wherein the device is inflatable.

41. The device of claim 39 wherein the device comprises a low spring constant material.

42. The device of claim 40 wherein the device further comprises a plurality of separately inflatable compartments.

43. An effective, low cost, easy-to-manufacture device for promoting strength and flexibility in deep postural muscles in a patient comprising:
an elongated member having a low spring coefficient and two ends; and
handhold means for securing the device located on either end of the elongated member.

44. The device of claim 43 wherein the elongated member further includes a top end and a bottom end; and
and the bottom end includes a protuberance adapted for a patient's upper thoracic spinal region.

45. The device of claim 44 wherein the bottom end further comprises arcuate recesses complimentary to the patient's shoulders.
